(19) United States
(12) Patent Application Publication
(10) Pub. No.: US 2005/0029087 A1
(43) Pub. Date: Feb. 10, 2005

(54) Method for recovering activity of ion exchanger and agent for use in recovering activity of anion exchanger

(75) Inventors: Mari Kamegai, Tokyo (JP); Daijiro Kobori, Tokyo (JP); Junpei Fukawa, Tokyo (JP); Chika Kenmochi, Tokyo (JP)

Correspondence Address: NORRIS, MCLAUGHLIN & MARCUS, PA, 875 THIRD STREET, 18TH FLOOR, NEW YORK, NY, 10022, US

(73) Assignee: Orango Corporation, Tokyo (JP)

(21) Appl. No.: 10/497,935

(22) PCT Filed: Dec. 3, 2002
(86) PCT No.: PCT/JP02/12675

(30) Foreign Application Priority Data
Dec. 6, 2001 (JP) 2001-373108
Oct. 29, 2002 (JP) 2002-315023

(51) Int. Cl. G01L 9/18; C25B 5/00

(52) U.S. Cl. 204/156; 204/525

(57) ABSTRACT

A performance-lowered ion exchanger hard to recover in performance by the conventional regeneration (ion exchange resin, ion exchange membrane, or the like) is endowed with the same electric charge as the electric charge of the ion exchanger. A performance-lowered ion exchanger hard to recover in performance by the conventional regeneration owing to adsorption thereon of a charged substance is endowed with an electric charge opposite to that of the charged substance. According to the foregoing operations, the ion exchangers are recovered in performance. At least one compound selected from among organic amine compounds and organic ammonium compounds, which are capable of being endowed with an electric charge through dissociation thereof in solution, is preferably used as a rejuvenation agent for an anion exchanger.

### TECHNICAL FIELD

The present invention relates to a method of rejuvenating an ion exchanger (ion exchange resin, ion exchange membrane, etc.) which has undergone deterioration in performance and a rejuvenation agent for an anion exchanger, and particularly to a method of rejuvenating an anion exchange resin contaminated with matter leached out of a cation exchange resin and a rejuvenation agent for an anion exchanger. In the instant description, the term “rejuvenation,” which is different from “regeneration” as will be detailedly described later, refers to a treatment through which an ion exchanger that has suffered deterioration in performance due to a fouling which deterioration cannot be remedied by the conventional regeneration, and hence cannot properly exhibit an ion exchangeability is rejuvenated by removal of foulants and the like.

### BACKGROUND ART

Ion exchangers are widely used for the purpose of purifying substances or the like purposes. For example, synthetic zeolite as an inorganic ion exchanger is used for softening water. Ion exchange membranes are used for concentrating and removing electrolytes by electrodialysis, producing table salt through seawater concentration, refining sugar solutions, and applying them to fuel cells. Ion exchange resins are used for water treatment, wastewater treatment, food production, drug separation and refining, hydrometallurgy, analyses, catalysis applications, etc.

Ion exchange resins in particular are used in many fields including fossil-fueled power plants, nuclear power plants, semiconductor production factories, and plants of general industries. Specifically, ion exchange resins are used in make-up water treatment units, condensate demineralizers, etc. at fossil-fueled power plants and nuclear power plants. In the make-up water treatment units, ionic components and the like in raw water are removed by ion exchange resins to produce deionized water having a conductivity of at most 1 μS/cm, with which system water in the power plants is replenished. In the condensate demineralizers, ion exchange resins are used for removing from condensate ionic components, corrosion products formed from constituent materials of the plants, and seawater components in case of leakage of seawater used as cooling water for condensers, and are required to attain such a high level of condensate treatment as to provide a conductivity of at most 0.1 μS/cm.

In semiconductor production factories, ion exchange resins are used, for example, in facilities where ultrapure water for use in the step of washing LSI chips and the like is produced, and are required to produce ultrapure water having a resistivity of at least 18 M Ω·cm and an ion concentration of at most the ppt order in keeping with semiconductor integration scaleup.

In plants of general industries, ion exchange resins are used not only in deionized water production equipment but also in a wide variety of applications such as decoloration and deionization of starch sugar or sucrose, metal recovery in chemical processes, and refining of chemical products, and are further widely used as acid or base solid catalysts in organic chemical reactions.

As described above, ion exchange resins, which are used in a variety of fields, suffer deterioration in performance due to organics in raw water, impurities in system water, etc. The performance of an ion exchange resin can usually be recovered through reversible regeneration treatment thereof with an acid, an alkali or the like. Where impurities are irreversibly adsorbed on an ion exchange resin, however, the performance thereof can hardly be recovered by the conventional regeneration treatment. For example, where an ion exchange resin has undergone deterioration with the lapse of time by oxidative degradation or the like, the ion exchange resin is partially or wholly replaced because the performance is hardly recovered through the conventional regeneration treatment. Here, “regeneration” is a treatment by which an ion exchange resin, the breakthrough point of which has been reached as it has been exhausted with substances to be removed in a solution being subjected to ion exchange action of the ion exchange resin (ion exchange treatment), is subjected to desorption of the substances adsorbed on the ion exchange resin through a reversible reaction to return the ion exchange resin back to an ionic form thereof capable of ion exchange adsorption. A chemical agent to be used in regeneration is called a regenerant. Ion exchange adsorption and regeneration are usually repeated. Examples of the regenerant include an aqueous sodium chloride solution usable for a Na form strongly acidic cation exchange resin in hard water softening treatment for obtaining soft water using the resin, and hydrochloric acid or sulfuric acid usable for an H form strongly acidic cation exchange resin and an aqueous sodium hydroxide solution usable for an OH form strongly basic anion exchange resin in deionization treatment for obtaining deionized water using the strongly acidic cation exchange resin and the strongly basic anion exchange resin.

Many methods of performance recovery treatment of an ion exchange resin which is hardly recoverable in performance by the conventional regeneration are reported, examples of which include a method wherein heavy metals such as iron and organics adsorbed on an anion exchange resin are removed using a variety of reducing agent solution such as a nitric acid solution or hydrochloric acid, a method wherein organics adsorbed on an anion exchange resin are removed using an organic solvent, and a method wherein fine iron oxide particles (clad) and the like adsorbed on a cation exchange resin are removed by scrubbing treatment.

However, the method of removing heavy metals such as iron and organics adsorbed on an anion exchange resin using a nitric acid solution or hydrochloric acid is believed to be ineffective for polymeric substances (matter leached out of resin, etc.). The method of removing organics adsorbed on an anion exchange resin by an organic solvent is believed to be ineffective for adsorbed matter insoluble in the organic solvent and also to involve a problem of waste recovery. The method of removing clad adsorbed on a cation exchange resin by scrubbing treatment is believed to involve a possibility that the ion exchange resin is abraded and deteriorated by scrubbing. Further, none of the foregoing methods are effective for rejuvenation of an ion exchange resin contaminated with a substance that is matter leached out of an ion exchange resin having an opposite electric charge like matter leached out of a cation exchange resin as against an anion exchange resin.

For example, a method wherein an anion exchange resin is brought into contact with warm water of 50 to 60° C. for at least 12 hours has been proposed as a method of rejuvenating an anion exchange resin on which matter leached out of a cation exchange resin is adsorbed (Japanese Patent Laid-Open No. 9-206605). Since the anion exchange resin has a weak resistance to heat, however, the above-mentioned method involves a fear of deteriorating the anion exchange resin.

Although the foregoing generic description has been made of problems with use applications and rejuvenation treatments of ion exchangers, particularly ion exchange resins, an anion exchange resin for use in the condensate demineralization columns of a condensate demineralizer in a circulating water system of facilities in a fossil-fueled or nuclear power plant will now be detailedly described as a representative example of ion exchangers.

At facilities in a fossil-fueled or nuclear power plant, steam used for driving a generator turbine is cooled to condensate with seawater or the like, and the condensate is heated again to steam for use in driving the generator turbine for generating electricity. Such a cycle is repeated. Water circulated through the system by such cycles is contaminated with various impurity ions, clad, etc. Thus, condensate must be purified to a high degree from the standpoint of preventing corrosion and scale deposition of a boiler, a steam generator, a nuclear reactor, etc., and reducing the radioactivity (accumulated particularly on clad and the like) causative of exposure of workers to radiation, so that various condensate purification apparatuses such as a mixed bed condensate demineralizer, a powder ion exchange resin filter, and a hollow fiber membrane filter are used alone or in combination midway of such a circulating water system. Where seawater is used as cooling water for the circulating system, the above-mentioned mixed bed condensate demineralizer plays an important role of a fail-safe for preventing occurrence of failure even in rare case of so-called seawater leakage because there are many cases where the fear of seawater leakage into condensate is hardly dismissed.

The mixed bed condensate demineralizer usually has an equipment structure comprising a water passage system comprising a plurality of condensate demineralization columns (hereinafter referred to briefly as “demineralization columns”) and a regeneration system for regenerating ion exchange resins used in the demineralization columns. In general, an H or NH₄ form strongly acidic cation exchange resin and an OH form strongly basic anion exchange resin are mixed with each other and packed in the demineralization columns.

Condensate is treated with the foregoing condensate demineralizer in the following manner. Specifically, condensate is passed in parallel through a plurality of demineralization columns disposed in parallel in the condensate demineralizer to remove impurity ions such as Na ions and Cl ions contained in condensate by ion exchange and to remove metal oxide impurities such as clad by filtration and physical adsorption, whereby purified treated water is obtained. The plurality of demineralization columns are provided in the condensate demineralizer in order to enable the equipment to be continuously run even if the performances of ion exchange resins have deteriorated with the lapse of time. More specifically, while continuously effecting demineralization treatment of condensate in the condensate demineralizer, a demineralization column reaches the so-called end point of water passage as a result of a pressure loss incurred by clad accumulation, a given throughput of treatment attained (a given quantity of water treated), an impurity ion breakthrough point of ion exchange resins reached in the demineralization column, etc. Since the condensate demineralizer is provided with the plurality of demineralization columns, only the demineralization column which has reached the end point of water passage can be cut off line from the water passage system while allowing water to be continuously passed through the remainder demineralization column(s).

The ion exchange resins in the off-line demineralization column is transferred to the regeneration system, where the ion exchange resins are regenerated in a regeneration column(s) (regeneration facilities). The ion exchange resins thus regenerated are returned back to a demineralization column and then to the water passage system. The regeneration comprises a removal step of washing away with water metal oxide impurities such as clad attached to the surfaces of the ion exchange resins through air scrubbing (air scrubbing is a kind of rejuvenation in connection with clad and the like as described above), a separation step of separating a cation exchange resin and an anion exchange resin from each other, and a desorption step of passing an acid regenerant such as hydrochloric acid or sulfuric acid through the separated cation exchange resin and passing an alkali regenerant such as sodium hydroxide through the separated anion exchange resin for desorbing respective impurity ions to regenerate the two ion exchange resins. Regeneration methods in the desorption step include a single column regeneration method wherein regeneration is effected after the anion exchange resin and the cation exchange resin are separated into the upper layer and the lower layer, respectively, due to a difference therebetween in sedimentation speed, and a separate column regeneration method wherein the two ion exchange resins are regenerated in separate regeneration columns after they are separated from each other due to a difference therebetween in sedimentation speed. The regenerated ion exchange resins are usually transferred to a storage tank and allowed to stand by until ion exchange resins in another demineralization column reaches the end point of water passage. The ion exchange resins which have reached the end point of water passage in said another demineralization column are withdrawn, and the ion exchange resins on standby are instead transferred to said another demineralization column. The cation exchange resin and the anion exchange resin are formed into a mixed bed, and are used for condensate treatment. Here, the cation exchange resin is usually mixed with the anion exchange resin through preliminary external premixing and postmixing in the demineralization column to form a mixed bed. Incidentally, there also is a method wherein the regenerated ion exchange resins are directly returned back to the original demineralization column without any storage tank.

The demineralization performance of the condensate demineralizer, i.e., the quality required of treated water obtained from this demineralizer, must satisfy a recent trend of higher and higher purity requirement from the standpoint of corrosion inhibition and scaling prevention in boilers, steam generators, nuclear reactors, etc. For example, numerical targets of the Na ion, Cl ion and SO₄ ion in treated water are all at most 0.1 μg/L (liter, the same will apply hereinafter), desirably at most 0.01 μg/L. The foregoing impurities usually are captured by ion exchange resins in condensate demineralization columns. When the performances of the ion exchange resins deteriorate, however, such impurities cannot completely be captured thereby and are partly leaked into effluent to be flowed into boilers, steam generators, nuclear reactors, etc., thereby to bring about troubles such as corrosion product formation and scale deposition. That is to say, ion exchange resins for use in demineralization columns, when repeatedly used for a long period of time through clad- and like-removing rejuvenation treatment and regeneration treatment as described above, unavoidably undergo deterioration of performance little by little. If ion exchange resins, the ion exchange performances of which have become not sufficiently recoverable even through clad- and like-removing rejuvenation treatment and regeneration treatment, can be used for a long period of time by recovering the performances thereof through rejuvenation treatment, conventionally wasted materials can be effectively reused. This can attain a decrease in the amount of waste to a great advantage particularly in nuclear power plants. This can also decrease the running cost of the condensate demineralization system. The trend of performance drop is especially notable in anion exchange resins. This performance drop is attributed to contamination of the anion exchange resins with organics and the like.

According to the recent studies on ion exchange resins for use in condensate demineralizers at power plants, it has become apparent that the reaction rate of an anion exchange resin is lowered due to influences thereon of a cation exchange resin. Specifically, a cation exchange resin having Fe ions and Cu ions adsorbed thereon from water undergoes oxidative degradation, though very little, through contact thereof with dissolved oxygen in water and oxygen in air with the catalysis of such heavy metal ions to yield oligomers and low-molecular polymers of styrenesulfonic acid, which are part of the matrix structure of the cation exchange resin, whereby such leached-out degradation products are adsorbed on and contaminate the surfaces of the anion exchange resin to become a grave cause of lowering the reactivity of the anion exchange resin. When the reactivity of the anion exchange resin is lowered, matter leached out of the cation exchange resin cannot be captured by the anion exchange resin to remain in treated water obtained by treatment with the condensate demineralizer and hence flows in boilers, steam generators, nuclear reactors, etc., thereby to yield CO₂ and SO₄− through thermal decomposition thereof under high temperatures. As a result, the amount of ions increases and any leakage of seawater into the condenser cannot be coped with, thus lowering the quality of treated water obtained by treatment with the condensate demineralizer. These degradation products cannot easily be desorbed from the anion exchange resin by the conventional ion exchange resin regeneration method. This is believed to be a cause of the notable tendency of ever deteriorating the performance of anion exchange resins.

In an ion exchange treatment unit of common water treatment equipment such as deionized water production equipment, there has also been confirmed a phenomenon that an anion exchange resin affects a cation exchange resin to lower the reaction rate of the cation exchange resin, as opposed to the phenomenon observed in condensate demineralizers at power plants.

An object of the present invention, which has been made in view of the foregoing circumstances, is to provide a method of rejuvenating ion exchangers according to which an ion exchanger, the performance of which has deteriorated and been rendered not recoverable through the conventional regeneration, can be effectively rejuvenated without substantially damaging the ion exchanger. Another object of the present invention is to provide a rejuvenation agent for anion exchangers.

### DISCLOSURE OF THE INVENTION

In order to accomplish the foregoing objects, the present invention provides the following ion exchanger rejuvenation methods (1) to (9) and the following anion exchanger rejuvenation agent (10). In the instant description, the term “rejuvenation,” which is different from the foregoing “regeneration,” refers to a treatment through which the performance of an ion exchanger, lowered in performance by contamination not permitting of recovering the performance thereof by the conventional regeneration because of irreversible adsorption thereon of impurities and hence being incapable of properly exhibiting an ion exchangeability, is recovered by foulant removal and the like. Specifically, in the instant description, the term “rejuvenation” refers to an operation of contacting an ion exchanger with a chemical agent different from any regenerants for use in the conventional regeneration, thereby desorbing matter (foulants) hardly desorbable by the conventional regeneration periodically or non-periodically when the ion exchanger has the foulants accumulated thereon and is rendered incapable of attaining any hoped-for performance in the course of repetition of the foregoing ion exchange treatment and regeneration, and the term “rejuvenation agent” refers to a chemical agent for use in rejuvenation.

(1) An ion exchanger rejuvenation method characterized in that an ion exchanger lowered in performance is provided with the same electric charge as the electric charge of the ion exchange groups of said exchanger.

(2) An ion exchanger rejuvenation method characterized in that an ion exchanger lowered in performance through adsorption thereon of a charged substance is provided with an electric charge opposite to the electric charge of said charged substance.

(3) An ion exchanger rejuvenation method of (1) or (2), wherein said ion exchanger lowered in performance is an anion exchanger having a negatively charged substance adsorbed on the surfaces thereof.

(4) An ion exchanger rejuvenation method of (2) or (3), wherein the charged substance adsorbed on the surfaces of the ion exchanger is matter leached out of a cation exchanger.

(5) An ion exchanger rejuvenation method of any one of (1) to (4), wherein said ion exchanger is contacted with a charged substance to provide said ion exchanger with an electric charge.

(6) An ion exchanger rejuvenation method of (5), wherein the charged substance to be contacted with said ion exchanger is a substance which is endowed with an electric charge through dissociation thereof in solution.

(7) An ion exchanger rejuvenation method of (6), wherein said ion exchanger lowered in performance is an anion exchanger having a negatively charged substance adsorbed on the surfaces thereof, and wherein the substance which is endowed with an electric charge through dissociation thereof in solution is at least one compound selected from among organic amine compounds and organic ammonium compounds.

(8) An ion exchanger rejuvenation method of (7), wherein said at least one compound is selected from among trimethylamine and hydroxide and salts thereof, and hydroxide and salts of benzyltrimethylammonium.

(9) An ion exchanger rejuvenation method of any one of (1) to (8), wherein said ion exchanger is an ion exchange resin.

(10) An anion exchanger rejuvenation agent comprising at least one compound selected from among organic amine compounds and organic ammonium compounds, which are capable of being endowed with an electric charge through dissociation thereof in solution.

The reason for recovery, or revival, of the performance of an ion exchanger according to the present invention is not necessarily clear but is believed to be as follows: For example, where an ion exchanger having a charged substance adsorbed on the surfaces thereof is contacted with a substance having an electric charge opposite to that of the adsorbed substance, it is believed that the contacted substance is bonded to the adsorbed substance to work toward neutralization of the surface charge of the ion exchanger, and a substance resulting from bonding of the contacted substance to the adsorbed substance separates from the surfaces of the ion exchanger, whereby the substance adsorbed on the surfaces of the ion exchanger is desorbed to recover the performance of the ion exchanger.

A case of an ion exchange resin will be described in detail by way of example. When a cation exchange resin is deteriorated by oxidation and the like, polymeric organics with sulfonic groups that constitute the skeleton of the resin are leached out of the cation exchange resin. The leached-out polymeric organics are a substance having a negative electric charge, which is adsorbed on or attached to an anion exchange resin as the counterpart. This is believed to gravely lower the deionization capacity of the anion exchange resin. Specifically, it is believed that polymeric organics with sulfonic groups, leached out of the cation exchange resin, are charged negatively to repel anionic components in raw water, whereby the anionic components to be removed are not subjected to ion exchange treatment and are therefore leaked into treated water.

Thus, when a substance having an opposite positive electric charge (e.g., trimethylamine, benzyltrimethylammonium hydroxide, or the like) to that of the polymeric organics with sulfonic groups as a substance having a negative electric charge are given to the anion exchange resin, the polymeric organics with sulfonic groups, i.e., the adsorbed substance, are bonded to the positively charged substance, i.e., the contacted substance, whereby the polymeric organics with sulfonic groups, adsorbed on the anion exchange resin, are desorbed from the anion exchange resin. In other words, the ion exchange resin is subjected to performance recovery treatment (i.e., rejuvenation treatment).

Although the foregoing rejuvenation method has been described in connection with the case where negatively charged matter leached out of the cation exchange resin is adsorbed on the anion exchange resin, this method can be applied to a case where other negatively charged organics in raw water are adsorbed thereon. It can also be similarly applied to an opposite case where positively charged matter leached out of an anion exchange resin is adsorbed on or attached to a cation exchange resin, and a case where other positively charged matter in raw water is adsorbed thereon.

### BEST MODES FOR CARRYING OUT THE INVENTION

The present invention will now be described in further detail. Incidentally, the following description is made of an ion exchange resin, but it goes without saying that the same will apply to other ion exchangers such as ion exchange membranes.

One mode of this invention is a case where an ion exchange resin lowered in performance is endowed with the same electric charge as that of ion exchange groups of the ion exchange resin. In this case, employable methods of providing the ion exchange resin with the same electric charge as that of the ion exchange groups thereof include a method wherein the ion exchange resin is immersed in a chemical charged with an electric charge opposite to that of the ion exchange groups thereof, and a method wherein a chemical charged with an electric charge opposite to that of the ion exchange groups of the ion exchange resin is passed through the ion exchange resin.

Other mode of this invention is a case where an ion exchange resin lowered in performance through adsorption, on the surfaces thereof, of a substance having an electric charge (charged substance) is contacted with a substance having an opposite electric charge (counter charge) to that of the substance adsorbed on the surfaces of the ion exchange resin. In this case, employable methods of contacting the ion exchange resin with a substance having an electric charge opposite to that of the adsorbed substance include a method wherein the ion exchange resin is immersed in a chemical charged with an electric charge opposite to that of the adsorbed substance, and a method wherein a chemical charged with an electric charge opposite to that of the adsorbed substance is passed through the ion exchange resin.

More specifically, where the ion exchange resin is an anion exchange resin having a negatively charged substance (e.g., matter leached out of a cation exchange resin) adsorbed on the surfaces thereof, either any organic or any inorganic substances, irrespective of molecular weight, can be used as positively charged substances to be contacted with the anion exchange resin insofar as they are positively charged after dissociated in solution. Of organic substances, at least one selected from among the foregoing organic amine compounds and organic ammonium compounds capable of having an electric charge through dissociation thereof in solution is preferably used as an anion exchange resin rejuvenation agent. Organic amine compounds include primary to tertiary organic amines, examples of which include dimethylamine, trimethylamine, propylamine, butylamine, triethylamine, and tributylamine, while hydroxides of them and various salts (amine salts) of them including halides such as chlorides can be mentioned as organic ammonium compounds. Further, hydroxides and various salts, including halides such as chlorides, of benzyltrimetylammonium, tetraethylammonium, and tetrabutylammonium can be mentioned as quaternary organic ammonium compounds. Although any type of them is recognized as effective, use of a tertiary organic amine (or hydroxide or a salt thereof) or a quaternary organic ammonium compound is preferred in an aspect of chemical stability. A chemical having the same component as contained in the anion exchange resin, such as trimethylamine (or hydroxide or a salt thereof) or a benzyltrimethylammonium compound (hydroxide or a salt thereof), can be suitably used because the anion exchange resin will not be contaminated with the rejuvenation agent. Further, (co)polymers of a monomer(s) having an amino group or an ammonium group are preferred as organic amine compounds and organic ammonium compounds, examples of which include polyaminoalkyl (meth)acrylates and copolymers containing the monomer unit thereof, such as quaternary methyl chloride salt of polydimethylaminoethyl methacrylate, tertiary hydrochloric acid salt of polydimethylaminoethyl methacrylate, quaternary benzyl chloride salt of polydimethylaminoethyl methacrylate, quaternary methyl chloride salt of polydimethylaminoethyl acrylate, tertiary hydrochloric acid salt of polydimethylaminoethyl acrylate, and quaternary benzyl chloride salt of polydimethylaminoethyl acrylate; polyaminomethylacrylamide; polydiallylammonium halides; polydimethyldiallylammonium halides such as polydimethyldiallylammonium chloride; polyvinylpyridinium halides; polyvinylimidazoline; chitosane; epoxyamine compounds; epichlorohydrin-dimethylamine condensate; dicyandiamide-formaldehyde condensate; and styrene-dimethylaminoethyl methacrylate copolymers; etc., wherein those in salt form may also be used after turned into hydroxide form. Further, positively charged substances, which can also be sufficiently effectively used, include cationic surfactants such as long-chain alkylamine salts and quaternary ammonium salts, and solutions of highly selective inorganic cations such as barium ions, lead ions, or strontium ions, etc.

On the other hand, where the ion exchange resin is a cation exchange resin having a positively charged substance (e.g., matter leached out of an anion exchange resin) adsorbed on the surfaces thereof, either any organic or any inorganic substances, regardless of molecular weight, may be used as negatively charged substances to be contacted with the cation exchange resin insofar as they are negatively charged after dissociated in solution. Especially effective organic substances include sulfonic acids such as dimethylsulfonic acid, and carboxylic acids such as salicylic acid, citric acid, and oxalic acid. A chemical having the same components as contained in the cation exchange resin, such as benzenesulfonic acid and polystyrenesulfonic acid, can be suitably used because the cation exchange resin will not be contaminated with the rejuvenation agent. Further, negatively charged substances, which can also be sufficiently effectively used, include anionic surfactants such as alkylbenzenesulfonic acid salts, alkylnaphthalenesulfonic acid salts, alkylsulfosuccinic acid salts, and alkylphosphoric acid salts; solutions of highly selective inorganic ions such as iodine ions and bromine ions; metal oxides; silicone compounds; etc.

### EXAMPLES

The following Examples will specifically illustrate the present invention, but should not be construed as limiting the scope of the invention. The performance of an anion exchange resin is conveniently evaluated by a method wherein the mass transfer coefficient “MTC” thereof is measured as a yardstick of the reaction rate thereof. The MTC measurement method, which was used in the following Examples, will be summarized.

A (rejuvenated) anion exchange resin (Amberlite IRA900 manufactured by Rohm and Haas Company) is mixed with a virgin cation exchange resin (Amberlite 200CP manufactured by Rohm and Haas Company) in the H form at a (rejuvenated) anion exchange resin/cation exchange resin volume ratio=1/2. They are then packed in a column. Subsequently, ammonium ions (aqueous ammonia) and sodium sulfate in the form of an aqueous solution having a predetermined concentration are passed from the top of the column at a flow rate of 70 L/hr. Throughout water passage, inflowing water to and outflowing water from the column are collected to measure the sulfate ion concentrations thereof, and the porosity and the grain diameter of the anion exchange resin are measured after the completion of water passage. The mass transfer coefficient “MTC” is calculated according to the following formula. The higher the value, the higher the reaction rate of the anion exchange resin and, so to speak, the healthier the performance thereof. The MTC value of a virgin anion exchange resin is usually around 2.0 (×10⁻⁴ m/sec).

$$K = \frac{1}{6 ( 1 - ɛ ) R} \times \frac{F}{A \times L} \times d ( {InC}_{0} \text{/} C )$$

wherein K: mass transfer coefficient “MTC” (m/sec), ε: porosity, R: proportion (volume ratio) of anion exchange resin to ion exchange resins, F: flow rate of water being passed (m³/sec), A: cross-sectional area of ion exchange resin bed (m²), L: height of ion exchange resin bed (m), d: grain diameter of ion exchange resins (m), Co: sulfate ion concentration of inflowing water, and C: sulfate ion concentration of outflowing water.

### Example 1

Matter (polystyrenesulfonic acid) leached out of a cation exchange resin (Amberlite 200CP manufactured by Rohm and Haas Company) was adsorbed on the surfaces of a virgin anion exchange resin (Amberlite IRA900 manufactured by Rohm and Haas Company) to lower the performance of the anion exchange resin. Thereafter, the performance-lowered anion exchange resin was subjected to a rejuvenation treatment (performance recovery treatment). A 0.1N aqueous solution of trimethylammonium (TMA) and a 0.1N aqueous solution of benzenetrimethylammonium hydroxide (BTA) were used as rejuvenation agents. The resin was immersed in each aqueous solution at rest at a resin/aqueous solution by volume=1/2 at room temperature for 16 hours. After the immersion, the aqueous solution coexisting with the resin was sufficiently washed off with deionized water. The performance of the resin was evaluated in terms of mass transfer coefficient (MTC), and is shown in Table 1. In Table 1, the results of the untreated resin and the resin immersed in ultrapure water under the same conditions as described above are also shown for comparison. It is understandable from Table 1 that the performance of the ion exchange resin lowered in performance can be recovered by a simple operation according to the present invention.

TABLE 1
MTC(×10⁻⁴ m/sec)

| Untreated | Ultrapure Water | 0.1N-TMA | 0.1N-BTA |
|---|---|---|---|
| 1.4 | 1.5 | 2.0 | 2.0 |

### Example 2

In this Example, an anion exchange resin used in each of real plants and lowered in performance was subjected to a rejuvenation treatment. The following resins A-E were used as resins.
Resin A: anion exchange resin used in plant A and lowered in performance
Resin B: anion exchange resin used in plant B and lowered in performance
Resin C: anion exchange resin used in plant C and lowered in performance
Resin D: anion exchange resin used in plant D and lowered in performance
Resin E: anion exchange resin used in plant E and lowered in performance

A 0.1N solution of trimethylammonium (TMA) was used as a rejuvenation agent. The resin was immersed in this aqueous solution at rest at a resin/aqueous solution by volume=1/2 at room temperature for 16 hours. After the immersion, the aqueous solution coexisting with the resin was sufficiently washed off with deionized water. The performance of the resin was evaluated in terms of mass transfer coefficient (MTC), and is shown in Table 2. In Table 2, the results of the untreated resins are also shown for comparison. It is understandable from Table 2 that the performance of an ion exchange resin lowered in performance can be recovered by a simple operation according to the present invention.

TABLE 2

MTC(×10⁻⁴ m/sec)

| Used Resin | Untreated | 0.1N-TMA |
|---|---|---|
| Resin A | 1.6 | 2.0 |
| Resin B | 0.9 | 1.6 |
| Resin C | 1.4 | 1.7 |
| Resin D | 1.4 | 2.0 |
| Resin E | 0.9 | 1.8 |

### Example 3

Polystyrenesulfonic acid that is a standard substance corresponding to matter leached out of a cation exchange resin was adsorbed on the surfaces of a virgin anion exchange resin (Amberlite IRA900 manufactured by Rohm and Haas Company) to lower the performance of the anion exchange resin. Thereafter, the performance-lowered anion exchange resin was subjected to a rejuvenation treatment. An aqueous polydimethyldiallylammonium hydroxide (PDMDAA) solution having a concentration of 50 ppb and an aqueous epichlorohydrin-dimethylamine condensate (EC-DMA) solution having a concentration of 10 ppb were used as rejuvenation agents. The resin was immersed in each aqueous solution at rest at a resin/aqueous solution by volume=1/2 at room temperature for 16 hours. After the immersion, the aqueous solution coexisting with the resin was sufficiently washed off with deionized water. The performance of the resin was evaluated in terms of mass transfer coefficient (MTC), and is shown in Table 3. In Table 3, the results of the untreated resin and the resin immersed in ultrapure water under the same conditions as described above are also shown for comparison. It is understandable from Table 3 that the performance of the ion exchange resin lowered in performance can be recovered by a simple operation according to the present invention.

TABLE 3
MTC(×10⁻⁴ m/sec)

| Untreated | Ultrapure Water | 50 ppb-PDMDAA | 10 ppb-EC-DMA |
|---|---|---|---|
| 0.7 | 1.1 | 1.8 | 1.7 |

### INDUSTRIAL APPLICABILITY

As described hereinbefore, a performance-lowered ion exchanger that is hard to recover in performance by the conventional regeneration can be effectively recovered in performance without damaging the ion exchanger according to the ion exchanger performance recovery method of the present invention. Therefore, prolongation of the life span of an ion exchanger and reduction of the quantity of waste can be attained according to the present invention.

1. A method of rejuvenating an ion exchanger, comprising providing an ion exchanger which has suffered deterioration in performance with the same electric charge as the electric charge of the ion exchange 5 groups of said exchanger.

2. A method of rejuvenating an ion exchanger as claimed in claim 1, wherein said ion exchanger which has suffered deterioration in performance is an anion exchanger having a negatively charged substance adsorbed on the surfaces thereof.

3. A method of rejuvenating an ion exchanger as claimed in claim 2, wherein the charged substance adsorbed on the surfaces of the ion exchanger is matter leached out of a cation exchanger.

4. A method of rejuvenating an ion exchanger as claimed in claim 1, wherein said ion exchanger is contacted with a charged substance to provide said ion exchanger with an electric charge.

5. A method of rejuvenating an ion exchanger as claimed in claim 4, wherein the charged substance to be contacted with said ion exchanger is a substance which is endowed with an electric charge through dissociation thereof in solution.

6. A method of rejuvenating an ion exchanger as claimed in claim 5, wherein said ion exchanger which has suffered deterioration in performance is an anion exchanger having a negatively charged substance adsorbed on the surfaces thereof, and that the substance which is endowed with an electric charge through dissociation thereof in solution is at least one compound selected from among organic amine compounds and organic ammonium compounds.

7. A method of rejuvenating an ion exchanger as claimed in claim 6, wherein said at least one compound is selected from among trimethylamine and hydroxide and salts thereof, and hydroxide and salts of benzyltrimethylammonium.

8. A method of rejuvenating an ion exchanger as claimed in claim 1, wherein said ion exchanger is an ion exchange resin.

9. A method of rejuvenating an ion exchanger, comprising providing an ion exchanger which has suffered deterioration in performance through adsorption thereon of a charged substance is with an electric charge opposite to the electric charge of said charged substance.

10. A method of rejuvenating an ion exchanger as claimed in claim 9, wherein said ion exchanger which has suffered deterioration in performance is an anion exchanger having a negatively charged substance adsorbed on the surfaces thereof.

11. A method of rejuvenating anion exchanger as claimed in claim 9, wherein the charged substance adsorbed on the surfaces of the ion exchanger is matter leached out of a cation exchanger.

12. A method of rejuvenating an ion exchanger as claimed in claim 9, wherein said ion exchanger is contacted with a charged substance to provide said ion exchanger with an electric charge.

13. A method of rejuvenating an ion exchanger as claimed in claim 12, wherein the charged substance to be contacted with said ion exchanger is a substance which is endowed with an electric charge through dissociation thereof in solution.

14. A method of rejuvenating an ion exchanger as claimed in claim 13, wherein said ion exchanger which has suffered deterioration in performance is an anion exchanger having a negatively charged substance adsorbed on the surfaces thereof, and that the substance which is endowed with an electric charge through dissociation thereof in solution is at least one compound selected from among organic amine compounds and organic ammonium compounds.

15. A method of rejuvenating an ion exchanger as claimed in claim 14, wherein said at least one compound is selected from among trimethylamine and hydroxide and salts thereof, and hydroxide and salts of benzyltrimethylammonium.

16. A method of rejuvenating an ion exchanger as claimed in claim 9, wherein said ion exchanger is an ion exchange resin.

17. A rejuvenation agent for an anion exchanger, comprising at least one compound selected from among organic amine compounds and organic ammonium compounds, which are capable of being endowed with an electric charge through dissociation thereof in solution.
